(19) United States
(12) Patent Application Publication
(10) Pub. No.: US 2015/0212507 A1
(43) Pub. Date: Jul. 30, 2015

(54) METHOD FOR SUPPORTING OPERATING AND CHANGEOVER PROCESSES

(71) Applicant: KRONES AG, Neutraubling (DE)

(72) Inventors: Wolfgang Hahn, Neutraubling (DE); Thomas Kellhammer, Neutraubling (DE); Markus Zölfl, Metten (DE); Timo Pronold, Regensburg (DE); Johannes Böhm, Neutraubling (DE); Christina Traub, Neutraubling (DE); Stefan Schmidt, Neutraubling (DE)

(21) Appl. No.: 14/428,661

(22) PCT Filed: Sep. 12, 2013
(86) PCT No.: PCT/EP2013/068869

§ 371 Date: Mar. 17, 2015

(30) Foreign Application Priority Data
Sep. 27, 2012 (DE) 10 2012 217 570.9

(51) Int. Cl. G05B 19/18

(52) U.S. Cl. CPC G05B 19/18; G05B 2219/32064

(57) ABSTRACT

A method and a corresponding device for supporting operating and/or changeover processes for a machine, in particular product type changeovers in the beverage processing industry. The method includes the creation of a description of the changeover process which can comprise a plurality of sub-steps, the processing of individual sub-steps, and the storing of the changeover process and/or the processed sub-steps.

### CROSS-REFERENCE TO RELATED APPLICATION

The present application is the United States national phase of International Patent Application No. PCT/EP2013/068869, filed Sep. 12, 2013, which application claims to German Application No. 10 2012 217 570.9, filed Sep. 27, 2012. The priority application is hereby incorporated by reference.

### FIELD OF THE DISCLOSURE

The present disclosure refers to a method and a device for supporting operating and/or changeover processes, in particular product type changeovers in the beverage processing industry.

### BACKGROUND

The prior art discloses devices and methods for detecting and handling malfunctions.

DE 10 2008 010076 A1, for instance, discloses a system for handling and/or treating packaging means, wherein—via a central control unit in the form of a computer—different packaging means formats are stored, with which the system for handling and/or treating packaging means can be controlled accordingly, so that the nominal values stored for the corresponding packaging means formats can be realized.

DE 10 2010 013884 A1 describes a mobile control and organization unit for monitoring machines and at least an interface for establishing a connection for transmitting data and/or measurement signals between the control and organization unit and at least one machine. In the event of the occurrence of a fault associated with the machine, the control and organization unit is adapted to suitably inform a person to be determined according to predefined failure criteria from the vicinity of the machine.

### SUMMARY OF THE DISCLOSURE

It is one aspect of the present disclosure to provide a method and a device for supporting operating and/or changeover processes.

That aspect occurs according to the disclosure by the method and the device for supporting operating and/or changeover processes, particularly product type changeovers in the beverage processing industry.

Therefore, the method for supporting operating and/or changeover processes comprises creating a description of the operating and/or changeover process which can comprise a plurality of sub-steps, processing individual sub-steps, and storing the operating and/or changeover process and/or the processed sub-steps. With this method it is possible to explain the operating and/or changeover process of any machine to any operator in small sub-steps, which enables an operator who might be inexperienced or normally works with different machines to perform a changeover process or one or several sub-steps of the operating and/or changeover process in a targeted manner.

In one embodiment, at least one of the steps creating, processing or storing is carried out at least in part with the help of a mobile device. The use of such a mobile device for creating a corresponding operating and/or changeover process permits an on-site analysis and an immediately-on-site documentation—by means of the mobile device—of the necessary steps that are required for the successful performance of the operating and/or changeover process. For instance, individual stages of sub-steps or of the whole changeover process can directly be created at the corresponding places of the machine or the system, respectively.

In a further embodiment, the method provides that one or plural operating and/or changeover processes and/or sub-steps are selected among a number of presets which conform to already preset operating and/or changeover processes and/or preset sub-steps or comprise the same and are preferably stored in a database. By providing preset operating and/or changeover processes or sub-steps the generation of a new operating and/or changeover process can be facilitated by resorting to the preset operating and/or changeover processes or sub-steps from the preset. The possibility of further processing the preset presets, for instance supplementing said presets by way of machine-specific details, is advantageous.

In one embodiment, the step “creating” comprises creating a digital image and/or video of the location/the machine at which the operating and/or changeover process and/or the sub-step is performed, and creating a digital image and/or video of the course of action of the operating and/or changeover process and/or of the sub-step, and further creating a creation instruction of the operating and/or changeover process and/or of the sub-step, and storing additional data, for instance current and previously used product types, and storing the data in a database. The provision of the operating and/or changeover process and/or the sub-steps with corresponding images or videos of the location or of the course of action of the operating and/or changeover process and/or of the sub-step and the insertion of creation instructions and the storage of additional data can considerably facilitate an operator's handling of the machines during the changeover process.

In one embodiment, the method is characterized in that the step “processing” further comprises the management of the operating and/or changeover process and/or the sub-steps and the definition of the location of the operating and/or changeover process and/or the sub-step with the help of coding provided on the machine to be changed over, and the generation of workflows for users and the distribution of individual workflows and/or individual sub-steps and/or the operating and/or changeover process to end devices. The generation of individual workflows, particularly for specific users, allows an efficient coordination of a whole operating and/or changeover process, which can considerably reduce the expenditure of time, particularly in operating and/or changeover processes which include multiple sub-steps.

In a further embodiment, the method is characterized in that the changeover process and/or the sub-steps are entered into given standard masks. This facilitates the creation of new operating and/or changeover processes or sub-steps, respectively, because an operator can thereby at least resort to a standardized basic structure.

By using this method one can provide a device for supporting operating and/or changeover processes, in particular product type changeovers in the beverage processing industry, the device comprising at least one input means for creating a description of the operating and/or changeover process which can include multiple sub-steps and for processing the individual sub-steps, and the device further comprising a data storage device in which the operating and/or changeover process and/or the sub-steps can be stored. Especially with the input means provided for, the device enables an operator to generate operating and/or changeover processes, including the possibly provided sub-steps, by way of a corresponding interface. It is further ensured by the provision of a data storage device that the created operating and/or changeover processes and/or sub-steps can be accessed also at a later time.

In one embodiment, the device is formed such that the input means includes a mobile device or is a mobile device. With the help of a mobile end device it is possible to record, for instance, photos or videos at the concrete locations at which the operating and/or changeover process and/or the sub-step takes place or at which steps have to be carried out by an operator. Furthermore, the creation of the operating and/or changeover process or sub-steps can be facilitated because an operator can directly carry out the description on the machine and can thus also incorporate the local conditions into the description.

In a further embodiment, a preset store which may be identical with the data storage device is provided, in which preset settings for operating and/or changeover processes and/or sub-steps can be stored. In accessing this preset memory an operator is enabled to resort to already known and preset operating and/or changeover processes and/or sub-steps and thus to perform the creation of a new operating and/or changeover process within a shorter period of time or to resort to the stored one when an already known operating and/or changeover process is to be created of a machine of the same construction.

In one embodiment, the device provides that the input means is adapted to produce digital images and/or videos, creation instructions of the operating and/or changeover process and/or of the sub-step, and also that the input means and the data storage device are adapted to store additional data, for instance current and previously used product types. It is e.g. possible to create a detailed and correct description of the operating and/or changeover process and/or a sub-step which also enables other operators to carry out the operating and/or changeover process.

In one embodiment, the input means and the data storage device are adapted to manage the operating and/or changeover process and/or sub-steps, to generate a definition of the location of the operating and/or changeover process and/or the sub-step with the help of coding provided on the machine to be changed over, to generate workflows for users, and to distribute individual workflows and/or individual sub-steps and/or the operating and changeover processes to all devices. This ensures an organization of the necessary work for an operating and/or changeover process that is as time-saving and efficient as possible, which can minimize downtimes of machines.

In one embodiment, the device includes that the input means and the data storage device are adapted to provide standard masks into which the operating and/or changeover process and/or the sub-steps can be incorporated.

The provision of a standard mask allows, on the one hand, a simplified creation of operating and/or changeover processes and/or sub-steps and ensures, on the other hand, a uniform representation of the operating and/or changeover process.

### BRIEF DESCRIPTION

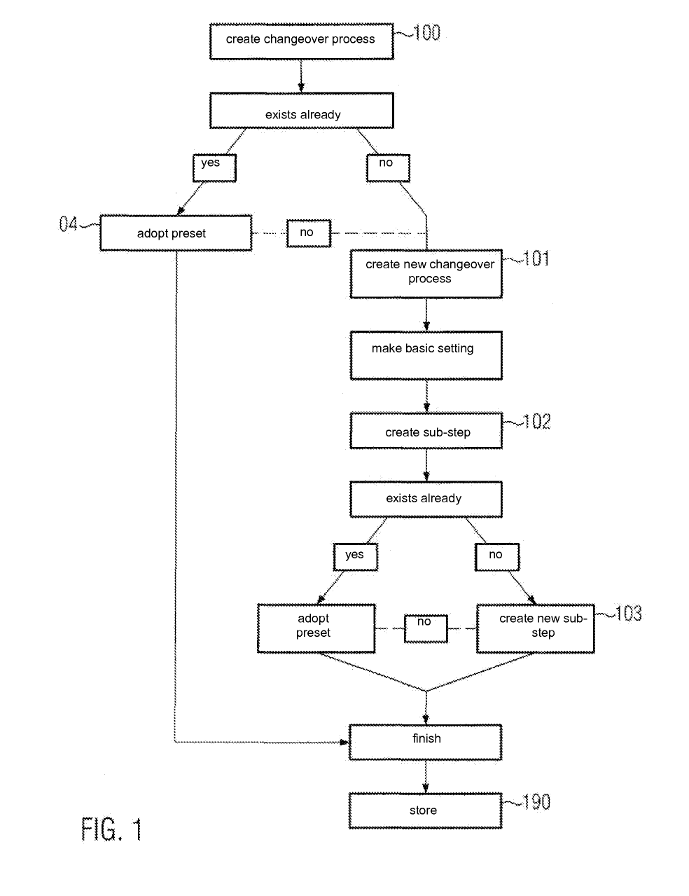

FIG. 1 flow diagram of a changeover process;

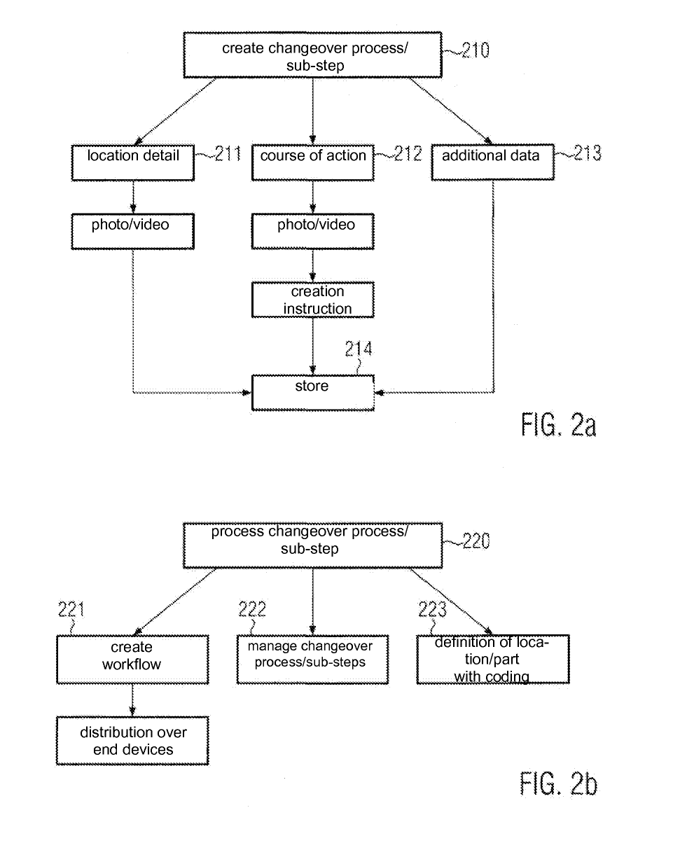

FIG. 2 detailed flow diagram of the creation of the changeover process and processing of the changeover process or sub-step, respectively;

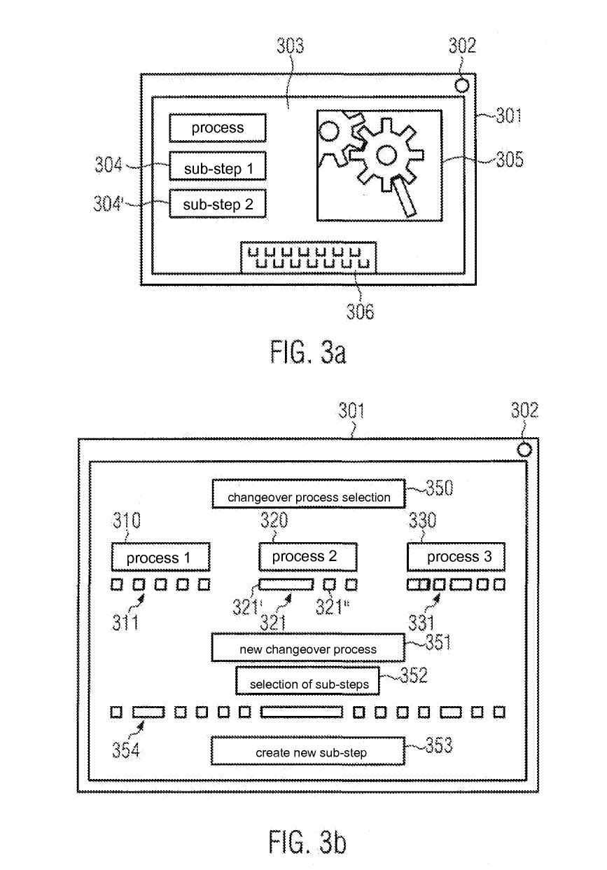

FIG. 3 schematic illustration of a device according to the disclosure;

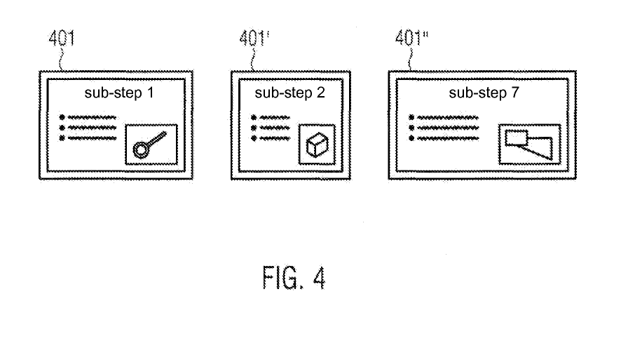

FIG. 4 schematic illustration of several devices according to the disclosure with distributed work flow.

### DETAILED DESCRIPTION OF THE FIGURES

It should be noted that the devices and methods described herein are used not only for the changeover processes described hereinafter, but can also be employed for supporting operating processes (maintenance and repair processes or trouble shooting, supply and disposal of consumables, etc.). For instance, operators of a machine are more and more confronted with preventive maintenance tasks for which system-specific instructions have to be created and updated. Furthermore, the described devices and methods can also be used for the new creation of process steps, for instance, for new product types (new types, etc.). Therefore, if features of relevance to the disclosure are described with respect to a changeover process, this equally regards an operating process or the new creation of process steps for instance for new product series.

FIG. 1 shows a schematic representation for the creation of a changeover process 100. Before a changeover process is newly generated, a query can be made through a corresponding program whether the new changeover process 100 already exists. This can e.g. be done by way of a series of questions addressed to the operator or through the operator's keyword search in a database.

If it is detected that this changeover process already exists, the corresponding changeover process can be selected and adopted among a number of presets stored preferably in a database 104. The corresponding process can then be finished as a new changeover process 100 and stored 190. If a corresponding changeover process 100 does not yet exist among the presets or if changes are desired, a new changeover process 101 may be created. A few basic settings can be defined for this new changeover process, for instance designations, and one or multiple sub-sets 102 are then defined.

In this case, too, there is advantageously a memory in which presets are stored for corresponding sub-sets. It is checked whether a preset already exists for a corresponding sub-set. This can e.g. be done by way of a number of questions addressed to the operator or by way of the operator's keyword search in the database. If this is the case, the corresponding preset can be adopted and the sub-step can be finished and stored 109. If the corresponding sub-step does not exist yet or if modifications are needed, for instance on account of the fact that the changeover process is carried out at the corresponding machine in a different way than is common due to unique constructional conditions, a new sub-step can be created 103. If all sub-steps have successively been created in this way and provided with the necessary information, the whole changeover process 100 can be finished and stored 190.

It should be noted that it is basically possible to apply the above-described steps not only to the changeover of a system, but also to a changeover process which requires the changeover of a multitude of machines. This includes e.g. the changeover of a production to a combination or cross operation.

FIG. 2 shows a detailed flow diagram for creating and processing a changeover process or sub-step.

FIG. 2A shows the creation of a changeover process or sub-step. The creation 201 particularly encompasses the recording of location details 211 for the changeover process or sub-step. For instance, the location detail can particularly include data, which are as detailed as possible, on the location of the machine in the factory hall or on a specific position at which the changeover process must take place. Furthermore, when the changeover process or sub-step is created, photos or videos can be taken of the location to enable a third operator—also without instructions from the operator creating the changeover process or sub-step—to carry out the process or sub-step.

Furthermore, the creation of the changeover process or sub-step 210 can encompass a comprehensive description of the course of action 212 in which the individual steps to be carried out, e.g. manipulations, are described e.g. in the form of a brief overview or also in the form of complete texts or schematic illustrations. At the same time photos or also videos may be displayed for that purpose, the photos or videos being recorded with a corresponding mobile end device or, if standardized processes are concerned, they can be taken from a database. At the same time photos or videos that were recorded with a corresponding mobile end device may be provided for this purpose. Likewise, a corresponding creation instruction for the total changeover process or sub-step may be provided in the created course of action. Apart from the detailed statement on individual steps, this instruction also includes e.g. transitions of individual sub-steps or specific information on sequences and optionally conditions for carrying out individual sub-steps. Conditions regarding the execution of individual sub-steps may e.g. be dependencies on previous sub-steps. As an example, the detachment of a plug which is positioned under a cover could be intended in a second sub-step. The first sub-step comprises the disengagement of this cover, so that the plug is exposed. The condition for performing the second sub-step is therefore the execution of the first sub-step, so that the plug is exposed.

Furthermore, additional data may be provided that define the exact circumstances of the changeover process or sub-step. For instance, a specific changeover process can only be carried out in a reasonable way if a changeover from product A to product B and not to product C is to take place. The retrofitting of blow molding machines which are usually used in the beverage-processing industry serves as an example. For instance, it may be provided that a changeover of the blow molds of 1-liter bottles to both 1.5-liter bottles and 0.75-liter bottles is possible. As additional data for the corresponding changeover process or sub-steps, a piece of information could then be provided that indicates that the corresponding changeover process is suited either for the changeover of the production series to 0.75-liter bottles or another piece of information may indicate that the corresponding changeover process is only suited for retrofitting the blow molding machine to 1.5-liter bottles from 1-liter bottles. The detailed description given thereby for the created changeover process or sub-step can then be stored.

FIG. 2B is a schematic illustration of the processing of an already stored changeover process or sub-step 220. Based on the corresponding changeover process or sub-step, individual workflows can be defined for users 221. These workflows can be distributed to individual end devices that may be allotted to specific operators. The workflows thereby comprise a number of sub-steps which have been prepared for a specific operator. They can encompass tasks for specially trained operators and particularly ensure a minimization of the total downtime of the system by way of a corresponding time management of the individual sub-steps.

This is accomplished in that sub-steps are allocated to different operators such that there are no overlaps, if possible, which means that none of the operators has to wait for the completion of a sub-step of another operator, and the amount of work of each individual operator is simultaneously minimized, if possible. Furthermore, a management 222 of the changeover process or of the sub-steps is possible. This management can ensure the monitoring of the execution of the individual sub-steps and thereby detect the time of completion or the beginning of a sub-step and distribute it to the group of operators, so that they can react to possible delays. Moreover, it is possible to provide the sub-steps with even more accurate location data or e.g. exact workpiece data that are specified with the help of coding provided on the individual workpieces or at corresponding places of the machine. This can simultaneously ensure a monitoring of the progress of the changeover process or individual sub-steps.

FIG. 3 shows a schematic illustration of a device which can be used for performing the method according to the disclosure. The device 301 may e.g. be in the form of a Tablet PC or another mobile end device, such as common smartphones or also laptops. Of particular advantage is the configuration of the Tablet PC according to a touchpad which has an interactive interface. The end device 301 particularly preferably comprises a display surface 303 and a camera 302 which is suited for recording both digital images and videos. It is further preferred that the end device 301 has not only an internal memory, which can e.g. comprise the above-described presets, but also further means for wireless data transfer so as to communicate e.g. with other end devices or a central processing unit or a central memory.

A corresponding process with the necessary sub-steps 304 and 304′ can then be displayed on the interface 303, as shown in FIG. 3A. Preferably, the symbols shown in FIG. 3A are interactive, i.e. additional information can be displayed by clicking on the corresponding symbols 304, 304′. At the same time it may be provided that in the overview of the total process a schematic representation 305 or the corresponding image of the device or parts of the device are shown. If a specific sub-step is chosen, information or images of relevance to the corresponding sub-step can be displayed in addition or as a supplement to this image 305. It is advantageous for the creation and processing of the changeover process when the interface 303 of the end device 301 also comprises a keyboard 306 which allows corresponding entries for the individual processes or sub-steps. For instance, each changeover process and/or sub-step can be individually adapted to external conditions.

FIG. 3B shows a possible implementation of the already mentioned preset settings for changeover processes and/or sub-steps. When the program or operator detects that corresponding processes are stored for the searched changeover process in the data memory, said person can find a selection of possible processes 310, 320 and 330 by way of a corresponding changeover process selection 350. It is particularly preferred when changeover processes 310, 320, 330 that are stored for any desired changeover process to be created can be combined in any desired way, which can particularly also be true for the sub-steps contained. By way of corresponding touching or by way of entries into the end device 301 it is possible to select one or plural changeover processes 310, 320 and 330. It is particularly preferred when the sub-steps 311, 321 and 331 pertaining to the changeover processes 310, 320 and 330 are displayed. Furthermore, it is of advantage when a selection can also be made among these sub-steps.

For simplified operation it may be provided that the individual sub-steps are characterized by different coloring or sizes of the symbols. For instance in the group of the sub-steps 321 of the changeover process 320 one can find a sub-step 321′ whose symbol size differs from that of the sub-step 321″. The symbol size can e.g. be used as an indicator of the duration of the sub-step and makes it easier for an operator to take into account the duration of the sub-steps to be expected when creating a changeover process and the corresponding workflow and thereby to allow a distribution of individual sub-steps that is as efficient as possible to different operators.

If a completely new changeover process is to be created, it may be provided that the end device 301 comprises a corresponding menu item. By selecting this menu item or by way of a corresponding entry, this menu can be selected. Since a new changeover process requires the definition of corresponding sub-steps whose sequence is not per se defined, a selection of sub-steps 351 may be provided that covers all or a subset of frequently used sub-steps 354. Since a selection of all possible sub-steps that might be needed for any desired changeover process may be inexpedient, the sub-steps can be sorted in different groups or only a selection of frequently used sub-steps is displayed. Likewise, the generation of new sub-steps may be required when a new changeover process 351 is to be created. The corresponding menu entry 353 permits the generation of completely new sub-steps by activation or corresponding entry into the end device 301. A corresponding, preferably interactive, menu can then guide an operator through the creation of the sub-steps and e.g. ask said person to record corresponding digital images or videos and to enter additional information.

FIG. 4 shows a schematic representation of end devices 401, 401′ and 401″, which are prepared for different users. Different sub-steps are displayed for the various operators by allocation of corresponding workflows. A corresponding networking of the end devices 401, 401′ and 401″, e.g. with the help of a wireless network, can facilitate the coordination of the work. For instance an interactive display in the individual end devices 401, 401′ and 401″ serves to display whether one of the operators has already finished a sub-step which is needed for the execution of a further sub-step of another operator. For instance, a corresponding condition as long as it is not satisfied can be displayed in red and it can be provided with a green background as soon as an operator fulfills the corresponding sub-steps to signalize to the other operators that this sub-step has been completed. It is preferred that the individual workflows for the different operators of the end devices 401, 401′, and 401″ only display the sub-steps that have to be carried out by the corresponding operator so as to prevent overlap or inconsistencies by operators who also carry out sub-steps that were not intended for them. However, to give every operator an overview of the whole changeover process and thus to facilitate individual arrangements, a summary of all sub-steps in the form of key points or the like can be given. If individual sub-steps require the execution of the work by several operators at the same time, corresponding tasks can simultaneously be displayed on the corresponding end devices 401, 401′, 401″.

1. A method for supporting operating and/or changeover processes for a machine, the method executed by one or more processors programmed to perform the method, the method comprising:
creating, by the one or more processors, a description of the operating and/or changeover process which can comprise a plurality of sub-steps;
processing, by the one or more processors, individual sub-steps; and
storing, by the one or more processors, the operating and/or changeover process and/or the processed sub-steps.

2. The method according to claim 1, and at least one of the steps creating, processing, storing is carried out at least in part with the help of a mobile device.

3. The method according to claim 1, and one or plural operating and/or changeover processes and/or sub-steps are selected among a number of presets which conform to already preset operating and/or changeover processes and/or preset sub-steps or comprise the same and are stored in a central database.

4. The method according to claim 1, and the step creating a description further comprises:
creating, by the one or more processors, a digital image and/or video of the location at which the operating and/or changeover process and/or the sub-step is performed;
creating, by the one or more processors, a digital image and/or video of the course of action of the operating and/or changeover process and/or the sub-step;
creating, by the one or more processors, a creation instruction of the operating and/or changeover process and/or of the sub-step;
storing, by the one or more processors, additional data, for instance current and previously used product types; and
storing, by the one or more processors, the data in a database.

5. The method according to claim 1, the step of processing individual sub-steps further comprises:
managing, by the one or more processors, the operating and/or changeover process and/or the sub-steps;
generating, by the one or more processors, workflows for users;
distributing, by the one or more processors, individual workflows and/or individual sub-steps and/or the operating and/or changeover process to end devices;
defining, by the one or more processors, the location of the operating and/or changeover process and/or the sub-step with the help of coding provided on the machine to be changed over.

6. The method according to claim 1, and the operating and/or changeover process and/or the sub-steps are entered into given standard masks.

7. A device for supporting operating and/or changeover processes, comprising:
at least an input means for creating a description of the operating and/or changeover process which can include multiple sub-steps, and for processing the individual sub-steps; and
a data storage device in which the operating and/or changeover process and/or the sub-steps can be stored.

8. The device according to claim 7, and the input means includes a mobile device or is a mobile device.

9. The device according to claim 7, and a preset store is provided which may be identical with the data storage device, in which preset settings for operating and/or changeover processes and/or sub-steps can be stored.

10. The device according to claim 7, and the input means is adapted to one of:
produce digital images and/or videos;
generate a creation instruction of the changeover process and/or of the sub-step; and
the input means and the data storage device are adapted to store additional data.

11. The device according to claim 7, and the input means and the data storage device are adapted
to manage the operating and/or changeover process and/or sub-steps;
to generate a definition of the location of the operating and/or changeover process and/or the sub-step with the help of coding provided on the machine to be changed over,
to generate workflows for users;
to distribute individual workflows and/or individual sub-steps and/or the operating and changeover process to end devices.

12. The device according to claim 7, and the input means and the data storage device are adapted to provide standard masks into which the operating and/or changeover process and/or the sub-steps can be incorporated.

13. The method according to claim 1, and the method is for supporting product type changeovers for a machine in the beverage processing industry.

14. The device according to claim 7, and the device is for supporting product type changeovers in the beverage processing industry.

15. The device according to claim 7, and the additional data is for current and previously used product types.
